(19) United States
(12) Patent Application Publication
(10) Pub. No.: US 2026/0201502 A1
(43) Pub. Date: Jul. 16, 2026

(54) METHOD FOR THE OPTIMISATION OF FEED FOR DOWNSTREAM PROCESSING

(71) Applicant: IGO Limited, South Perth (AU)

(72) Inventors: Christopher Brett Ward, South Fremantle (AU); Christopher John Carr, Maida Vale (AU); Karel John Osten, North Perth (AU)

(73) Assignee: IGO Limited, South Perth (AU)

(21) Appl. No.: 19/119,067

(22) PCT Filed: Oct. 5, 2023
(86) PCT No.: PCT/AU2023/050968

§ 371 Date: Apr. 7, 2025

(30) Foreign Application Priority Data
Oct. 7, 2022 (AU) 2022902923
Oct. 17, 2022 (AU) 2022903049

(51) Int. Cl. C22B 3/00; C01C 1/24; C01G 51/10; C01G 53/10; C22B 3/08; C22B 3/38

(52) U.S. Cl. CPC C22B 23/043; C01C 1/24; C01G 51/10; C01G 53/10; C22B 3/08; C22B 3/38; C22B 23/0453

(57) ABSTRACT

A method for the optimisation of feed for downstream processing includes passing a sulphide ore concentrate to a first leach step, in which a leach discharge slurry is produced, passing an intermediate product to a second leach step, in which a pregnant leach solution is produced, and combining the leach discharge slurry of the fist leach step with the intermediate product in the second leach step. Residual acid generated in the first leach step is used to leach the intermediate product in the second leach step and provides the pregnant leach solution containing one or more target metals.

### FIELD OF THE INVENTION

The present invention relates to a method for the optimisation of feed for downstream processing.

More particularly, the method of the present invention utilises a leach of a nickel and cobalt containing sulphide concentrate and the subsequent exposure of a leach slurry discharge therefrom to a nickel and cobalt containing mixed hydroxide precipitate.

Further, the method of the present invention is intended to have particular application in the optimisation of feed for the production of precursor cathode active materials (PCAM).

### BACKGROUND ART

As demand for lithium-ion batteries expands in line with increasing sales of electric vehicles and energy storage systems, so too does the demand increase for high-quality battery raw materials. Both nickel sulphate and cobalt sulphate are critically important in certain electric vehicle battery cathodes, particularly for battery technologies using nickel-cobalt-manganese (NCM) and nickel-cobalt-aluminium (NCA) cathode chemistries. NCM and NCA technologies are becoming increasingly popular given their high energy density which, in electric vehicle applications, results in longer driving range. There is also a transition to increased proportions of nickel in the cathode for both these battery types.

Typically, nickel sulphate is produced from intermediate or refined nickel products that have been subject to multiple complex metallurgical methods. These additional methods have resulted in nickel sulphate trading at a premium to the LME nickel metal price. The quantum of the premium is largely driven by market supply and demand, quality and provenance.

Nickel and cobalt may be sourced from nickel and cobalt containing sulphide ores. As an initial step it is typical that a nickel and cobalt containing sulphide concentrate be prepared. This concentrate is then able to be processed in a hydrometallurgical circuit to extract and recover the target metals. The economies of the hydrometallurgical circuit employed generally require supply of feed to the circuit to be at or above a particular level for operational expenditure and capital intensity requirements to be realised. That is, if supply is below a certain level, either in terms of volume of feed, or quality of feed, then the hydrometallurgical circuit will not run efficiently.

It would be advantageous to provide a hydrometallurgical circuit that was sufficiently flexible to accommodate different or alternative feeds, allowing operational expenditure and capital intensity requirements to be realised, or at least improved, relative to a circuit that was operable with only a single feed source.

Additionally, hydrometallurgical process routes often include process steps that generate waste product streams, and/or reagents, that may not be utilised. Such products and/or reagents may need to be captured, stored and possible transported for any value to be realised therefrom. For example, the processing of sulphide minerals in acid leach steps can result in the production of excess acid. This acid will typically require neutralisation at a point downstream of the leach step. This neutralisation process consumes reagent.

It would be advantageous to provide a hydrometallurgical circuit that utilised acid produced in the processing of sulphide minerals to realise additional value in the process by way of recovery of additional target metals, such as nickel and cobalt.

The methods of the invention optimise the production of both nickel and cobalt sulphate directly from nickel and cobalt containing sulphide concentrates without the requirement to first produce intermediary or refined products.

In addition, the methods of the invention are more environmentally sustainable compared to the traditional production methods for nickel and cobalt sulphate, due to the method's significantly lower emissions, power consumption and waste generation. In addition, the nickel and cobalt sulphate recovery methods of the invention are advantageous over traditional evaporative crystallisation methods performed at ambient or near ambient conditions as the methods of the invention are significantly faster.

The methods and processes of the invention also lead to other saleable by products, including an ammonium sulphate (Amsul) by-product for use as a fertiliser.

Mines located in remote locations, including in particular nickel mines, can be costly to service with reagents and labour. For example, the high purity of battery products and the need for specific trace analyses and specialty skills are difficult to resource in remote locations.

Precursor cathode active materials (PCAM) are specialty chemicals and to date the scale of vessels used in their production is much smaller than the volumes used in nickel sulphate production. A semi-finished intermediate can be solubilised to achieve a much higher nickel tenor at a “polishing refinery” than can be accommodated in most direct mineral extraction processes. Transportation of ores or concentrates to coastal and city locations is understood to add significant operating expenditure to any project.

Disposal costs of solid wastes and effluents generated during processing of ores and concentrates away from the original mine site can be problematic and costly.

The Applicants believe that locating the extraction facility at an existing mine site will provide significant advantages relative to the processing methods of the prior art. For example, the approvals processes are expected to be less onerous and the timeline to construction and production is expected to be shorter.

The methods of the present invention have as one object thereof to overcome substantially one or more of the abovementioned problems of the prior art, or to at least provide useful alternatives thereto.

Throughout the specification, unless the context requires otherwise, the word “comprise” or variations such as “comprises” or “comprising”, will be understood to imply the inclusion of a stated integer or group of integers but not the exclusion of any other integer or group of integers.

Each document, reference, patent application or patent cited in this text is expressly incorporated herein in their entirety by reference, which means that it should be read and considered by the reader as part of this text. That the document, reference, patent application, or patent cited in this text is not repeated in this text is merely for reasons of brevity.

P80 defines the product size of a slurry by the particle size at which 80% of the particles by mass are smaller than that particle size. Similarly, Px defines the product size of a slurry by the particle size at which x % of the particles by mass are smaller than that particle size.

PLS refers to a pregnant leach solution. Clarified PLS refers a pregnant leach solution where solids of the slurry have been removed, for instance, by counter current decantation. Herein, when referring to a PLS that is downstream of the removal of the suspended solids in the method of the invention, except where the context requires otherwise, reference to a PLS is equivalent to a clarified PLS.

Use of the term POX herein, which refers to pressure oxidation, is to be understood to refer to high temperature pressure oxidation or HTPOX, unless the context suggests or requires otherwise.

It is to be understood that the ranges provided herein include the stated range and any value or sub-range within the stated range. For example, a range from about 50 minutes to about 100 minutes, or about 50 to 100 minutes, should be interpreted to include not only the explicitly recited limits of from between from about 50 minutes to about 100 minutes, but also to include individual values, such as about 60 minutes, about 70 minutes, about 80 minutes, etc., and sub-ranges, such as from about 55 minutes to about 75 minutes, from about 65 minutes to about 95 minutes, etc. Furthermore, when “about” and/or “substantially” are/is utilised to describe a value, they are meant to encompass minor variations (up to +/−10%) from the stated value.

Reference to cited material or information contained in the text should not be understood as a concession that the material or information was part of the common general knowledge or was known in Australia or any other country.

### DISCLOSURE OF THE INVENTION

In accordance with a first embodiment of the present invention there is provided a method for the optimisation of feed for downstream processing, the method comprising the method steps of:
(i) Passing a sulphide ore concentrate to a first leach step, in which is produced a leach discharge slurry;
(ii) Passing an intermediate product to a second leach step, in which is produced a pregnant leach solution; and
(iii) Combining the leach discharge slurry of step (i) with the mixed hydroxide precipitate of step (ii) in the second leach step,
   wherein residual acid generated in the first leach step is used to leach the intermediate product in the second leach step and provides a pregnant leach solution containing one or more target metals.

Preferably, the sulphide ore concentrate contains the target metals nickel and cobalt.

Still preferably, the intermediate product contains the target metals nickel and cobalt.

In one form, the intermediate product is a mixed hydroxide precipitate containing the target metals nickel and cobalt.

Preferably, the first leach step is a high temperature pressure oxidative leach.

Still preferably, the high temperature pressure oxidative leach operates with one or more of the following conditions:
(i) A pressure of between about 2500 to 3000 kPa;
(ii) An oxygen overpressure of between about 400-700 kPa, for example about 700 kPa;
(iii) A temperature of between about 200-220° C., for example about 210° C.;
(iv) A retention time of between 40 to 70 minutes, for example about 50 minutes; and/or
(v) Between about 15 to 30 g/L sulfuric acid, for example about 24 g/L sulfuric acid.

Preferably, the second leach step is operated with one or more of the following conditions:
(i) Atmospheric pressure;
(ii) A temperature of about 80° C.;
(iii) A retention time of between about 70-100 minutes, for example between about 78-97 minutes; and/or
(iv) A pH of between 2.8-3.

The pregnant leach solution from the second leach step is preferably passed to an iron removal step to substantially remove iron therefrom whilst retaining the or each target metal in solution. Preferably, aluminium is also removed in the iron removal step. Still preferably, the iron removal step comprises the modification of the pH of the pregnant leach solution so as to precipitate the iron and optionally aluminium.

The method of the present invention preferably further comprises an impurity removal step, in which a number of impurity elements are removed from the pregnant leach solution. In one form, these impurity elements include one or more of zinc, calcium, copper and manganese.

Preferably, the impurity removal step is provided in the form of a solvent extraction step. Still preferably, the solvent extraction step utilises an organophosphoric extractant, for example Di(2-ethylhexyl)phosphoric acid (DEPHA) in an aliphatic diluent.

The method of the present invention preferably still further comprises a nickel and cobalt recovery step, in which nickel and cobalt are recovered from the pregnant leach solution.

In one form, the nickel and cobalt recovery step is provided in the form of a solvent extraction step. Preferably, the nickel and cobalt recovery step provides the direct crystallisation of nickel and cobalt. Still preferably, an ammonium sulphate containing raffinate is produced in the solvent extraction step.

Preferably, the nickel is recovered in the form of nickel sulphate hexahydrate crystals. Preferably, the cobalt is recovered in the form of cobalt sulphate heptahydrate crystals.

The method of the present invention preferably further comprises a repulping step in which the recovered nickel and cobalt is repulped and a mixed nickel sulphate and cobalt sulphate solution produced.

Preferably, the mixed nickel sulphate and cobalt sulphate solution contains about 120 g/L nickel.

Still preferably, trace elements other than cobalt and manganese are present at levels at which the nickel to trace element ratio is >20,000 times.

In accordance with a second embodiment of the present invention there is further provided a method for the optimisation of feed for downstream processing, the method comprising the following method steps:
(i) Leaching an ore or concentrate at a first site to produce a pregnant leach solution containing one or more target metals;
(ii) Passing the pregnant leach solution to one or more impurity removal steps to produce an at least partially purified product;
(iii) Producing an intermediate product from the at least partially purified product from step (ii);
(iv) Transporting the intermediate product from step (iii) to a second site located remotely from the first site; and
(v) Conducting downstream processing of the intermediate product from step (iii) at the second site.

Preferably, the one or more target metals of step (i) include nickel and/or cobalt.

Still preferably, the one or more impurity removal steps of step (ii) comprise the precipitation of iron and aluminium.

Still further preferably, the one or more impurity removal steps of step (ii) further comprises an upgrade step. The upgrade step is preferably provided in the form of a solvent extraction step. The upgrade step still further preferably utilises a carboxylic acid extractant, for example Versatic 10™.

Preferably, step (iii) comprises the crystallisation of the intermediate product.

In one form of the present invention, step (iii) comprises the direct crystallisation of the intermediate product.

Preferably, the intermediate product of step (iii) is a metal sulphate intermediate.

Still preferably, the intermediate product of step (iii) is:
(i) an intermediate nickel sulphate; and/or
(ii) an intermediate cobalt sulphate.

In one form, the intermediate product of step (iii) further contains manganese sulphate.

The intermediate product is preferably produced in a manner that minimises its moisture content.

Preferably, the downstream processing of the intermediate product at the second site comprises one or more further impurity removal steps.

Still preferably, the further impurity removal steps comprise one or more ion exchange or solvent extraction steps.

In one form of the present invention the downstream processing of the intermediate product at the second site provides one or more precursor cathode active materials (PCAM).

The method of second embodiment of the present invention, wherein the method steps are conducted in accordance with the first embodiment of the present invention.

### DESCRIPTION OF THE DRAWINGS

The present invention will now be described, by way of example only, with reference to a first embodiment thereof and the accompanying drawings, in which:—

FIG. 1 is a diagrammatic representation of a flowsheet incorporating a method for the optimisation of downstream processing in accordance with the present invention; and

FIG. 2 is a diagrammatic representation of a flowsheet as utilised in the pilot plant of the example described hereinafter and employing the high temperature pressure oxidation leach of a flotation concentrate, leaching of a mixed hydroxide precipitate in a high temperature pressure oxidation leach discharge slurry, solid liquid separation and washing, and finally residual iron/aluminium precipitation.

### BEST MODE(S) FOR CARRYING OUT THE INVENTION

The present invention provides, in accordance with a first embodiment thereof, a method for the optimisation of feed for downstream processing, the method comprising the method steps of:
(i) Passing a sulphide ore concentrate to a first leach step, in which is produced a leach discharge slurry;
(ii) Passing an intermediate product to a second leach step, in which is produced a pregnant leach solution; and
(iii) Combining the leach discharge slurry of step (i) with the mixed hydroxide precipitate of step (ii) in the second leach step,
   wherein residual acid generated in the first leach step is used to leach the intermediate product in the second leach step and provides a pregnant leach solution containing one or more target metals.

The sulphide ore concentrate contains the target metals nickel and cobalt. The intermediate product contains the target metals nickel and cobalt. In one form, the intermediate product is a mixed hydroxide precipitate containing the target metals nickel and cobalt.

The first leach step is, in one form, a high temperature pressure oxidative leach. The high temperature pressure oxidative leach operates with one or more of the following conditions:
(i) A pressure of between about 2500 to 3000 kPa;
(ii) An oxygen overpressure of between about 400 to 700 kPa, for example about 700 kPa;
(iii) A temperature of between about 200 to 220° C., for example about 210° C.;
(iv) A retention time of between 40 to 70 minutes, for example about 50 minutes; and/or
(v) Between about 15 to 30 g/L sulfuric acid, for example about 24 g/L sulfuric acid.

The second leach step is operated with one or more of the following conditions:
(i) Atmospheric pressure;
(ii) A temperature of about 80° C.;
(iii) A retention time of between about 70-100 minutes, for example between about 78-97 minutes; and/or
(iv) A pH of between 2.8-3.

The pregnant leach solution from the second leach step is passed to an iron removal step to substantially remove iron therefrom whilst retaining the or each target metal in solution. Aluminium is also removed in the iron removal step. The iron removal step comprises the modification of the pH of the pregnant leach solution so as to precipitate the iron and optionally aluminium.

The method of the present invention further comprises an impurity removal step, in which a number of impurity elements are removed from the pregnant leach solution. In one form, these impurity elements include one or more of zinc, calcium, copper and manganese.

The impurity removal step may be provided in the form of a solvent extraction step. The solvent extraction step utilises an organophosphoric extractant, for example Di(2-ethylhexyl)phosphoric acid (DEPHA) in an aliphatic diluent.

The method of the present invention still further comprises a nickel and cobalt recovery step, in which nickel and cobalt are recovered from the pregnant leach solution.

In one form, the nickel and cobalt recovery step is provided in the form of a solvent extraction step. The nickel and cobalt recovery step provides the direct crystallisation of nickel and cobalt. An ammonium sulphate containing raffinate is produced in the solvent extraction step, from which an ammonium sulphate containing product may be produced.

The recovered nickel is recovered in the form of nickel sulphate hexahydrate crystals. The recovered cobalt is recovered in the form of cobalt sulphate heptahydrate crystals.

The method of the present invention, in one form, further comprises a repulping step in which the recovered nickel and cobalt is repulped and a mixed nickel sulphate and cobalt sulphate solution produced.

The target purity of the mixed nickel sulphate and cobalt sulphate solution is about 120 g/L nickel. Trace elements other than cobalt and manganese are intended to be controlled to levels at which the nickel to trace element ratio is >20,000 times.

One or more of the nickel sulphate hexahydrate crystals, cobalt sulphate heptahydrate crystals and/or the repulped mixed nickel sulphate and cobalt sulphate solution may constitute the intermediate product contemplated as the product of the step (iii) of the method for the optimisation of feed for downstream processing described immediately below.

The present invention further provides, in accordance with a second embodiment thereof, a method for the optimisation of feed for downstream processing, wherein the method comprises the following method steps:
(i) Leaching an ore or concentrate at a first site to produce a pregnant leach solution containing one or more target metals;
(ii) Passing the pregnant leach solution to one or more impurity removal steps to produce an at least partially purified product;
(iii) Producing an intermediate product from the at least partially purified product from step (ii);
(iv) Transporting the intermediate product from step (iii) to a second site located remotely from the first site; and
(v) Conducting downstream processing of the intermediate product from step (iii) at the second site.

The one or more target metals of step (i) include nickel and/or cobalt. The one or more impurity removal steps of step (ii) comprise the precipitation of iron and aluminium.

The one or more impurity removal steps of step (ii) further comprises an upgrade step. The upgrade step is, in one form of the invention, provided as a solvent extraction step. The upgrade step may utilise a carboxylic acid extractant, for example Versatic 10™.

Step (iii) comprises the crystallisation of the intermediate product. In one form of the present invention, step (iii) comprises the direct crystallisation of the intermediate product.

As described herein, the intermediate product of step (iii) is a metal sulphate intermediate. For example, this metal sulphate intermediate may be the mixed nickel sulphate and cobalt sulphate solution of the first form of the invention described immediate above. In one form, the metal sulphate intermediate may further contain manganese sulphate.

The intermediate product of step (iii) is, for example:
(i) an intermediate nickel sulphate; and/or
(ii) an intermediate cobalt sulphate.

The intermediate product is ideally produced in a manner that minimises its moisture content.

The downstream processing of the intermediate product at the second site may comprise one or more further impurity removal steps. The further impurity removal steps comprise one or more ion exchange or solvent extraction steps.

In one form of the present invention the downstream processing of the intermediate product at the second site provides feed solution for the production of one or more precursor cathode active materials (PCAM).

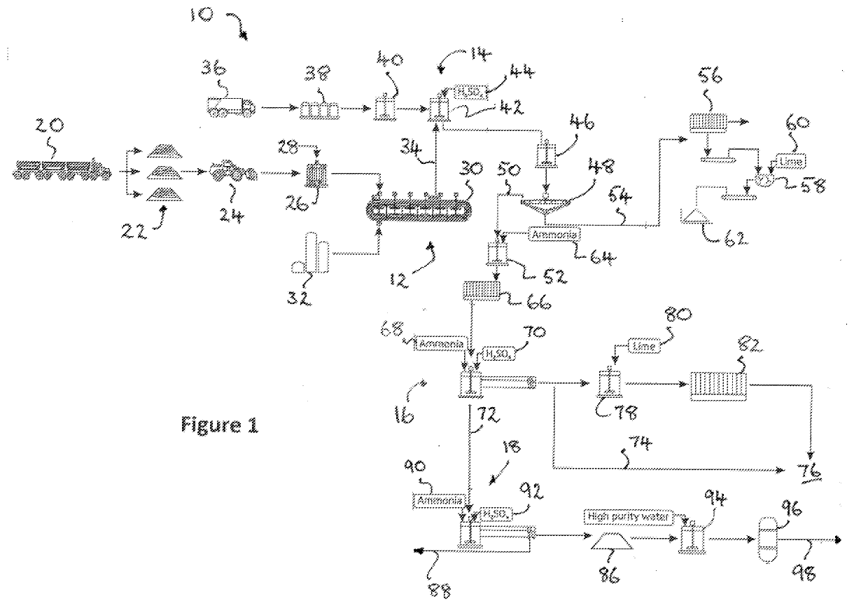

In FIG. 1 there is shown a method 10 for the optimisation of downstream processing in accordance with a first embodiment of the present invention, the method 10 comprising a first leach step 12, a second leach step 14, an impurity removal step 16 and a nickel and cobalt recovery step 18.

The method 10 further comprises the passing of a nickel and cobalt containing sulphide concentrate 20 to a blending step 22, from which the blended concentrate is transferred 24 to a concentrate repulp step 26, in which the pulp density of the concentrate feed may be adjusted by repulping in water 28.

The first leach step 12 is a high temperature pressure oxidation leach (HTPOX) conducted in one or more autoclaves 30, the or each autoclave receiving repulped concentrate from the repulp step 26, and oxygen from an oxygen plant 32. The flow of repulped concentrate is provided to the or each autoclave at a solids flow rate of, in test work, between about 1.8 to 2.7 kg/hr, for example at about 2.1 kg/hr. Flow rates in a commercial facility can be expected to be much greater, for example about 15 to 17 tonnes per hour. The leach is conducted under conditions of increased pressure, for example at about 2500 kPa autoclave pressure, oxygen overpressure, for example between about 400 to 700 kPa oxygen, increased temperature of greater than about 200° C., for example about 210° C., and with an autoclave retention time of between about 40 to 70 minutes, for example about 70 minutes. The first leach step operates with an acid range of between 15 to 30 g/L sulphuric acid. The first leach step 12 produces an autoclave discharge slurry 34 that contains a significant level of sulphuric acid, for example about 24 g/L.

A mixed hydroxide precipitate 36 (MHP) is transported to storage 38, from where it passed to an MHP repulp step 40, before being passed to one or more vessels 42 at about 25% w/w solids, and a flow rate of between about 0.20 to 0.35 tonne MHP solids per tonne of sulphide concentrate (t/t), for example, about 0.22 tonne MHP solids per tonne of sulphide concentrate (t/t). The target for the process of the present invention is to provide approximately equal tonnes of nickel from concentrate and from MHP, and the ranges recited are dependent on the level of sulphide sulphur in the concentrate feed. The second leach step 14 is undertaken in the one or more vessels 42 at atmospheric pressure and at a temperature of about 80° C., with a retention time of about 70 to 100 minutes, for example between 78 and 97 minutes. The acid content of the autoclave discharge slurry 34 is largely utilised in the leaching of nickel and cobalt from the MHP fed thereto. The autoclave discharge slurry 34 is fed to the vessel 42 at a rate of, for example, about 17.42 kg/h in testing performed by the Applicants. Additional sulphuric acid 44 may be added to the second leach step 14 if considered necessary, to increase the amount of available acid that in turn allows additional MHP to be leached and without exceeding the target pH range of about 2.8 to 3.

The second leach step 14 generates a pregnant leach solution (PLS) at, for example, a pH of 3.5 and that contains, for example, about 50 g/L nickel, about 20 mg/L Fe(t) and about 20 mg/L Al. Residual free acid in the PLS is about 0.9 g/L.

From the second leach step 14 the pregnant leach solution is passed to a primary neutralisation step 46, and in turn to a counter current decantation step 48, from which an overflow 50 of pregnant leach solution is passed to an iron removal step 52, and an underflow 54 is passed to filtration 56 and neutralisation 58 with lime 60 prior to storage/disposal 62. The Applicants have found less than about 0.8% nickel present in the residue which is principally nickel associated with silicates reporting to the underflow 54.

In the iron removal step 52, comprising one or more tanks, anhydrous ammonia 64 is sparged into the pregnant leach solution to increase the pH to about 4.5 to 5, for example 4.75, and precipitate iron and aluminium. Precipitation efficiencies in the order of about 97.7% for iron and about 96.3% for aluminium have been realised in test work conducted by the Applicants. Further, iron and aluminium are, for example, each removed to levels of about <1 mg/L.

The iron removal step 52 operates in combination with a polishing filtration step 66 to which the nickel and cobalt containing pregnant leach solution is passed, and in which the precipitates generated in the iron removal step 52 are removed.

The pregnant leach solution from the polishing filtration step 66 is passed to the impurity removal step 16. The impurity removal step 16 comprises a solvent extraction process, for example operated in a counter-current array of mixer-settlers comprising 4 extracting, 3 scrubbing and 2 stripping stages, without inter-stage pH control. The organic phase is, for example, an organophosphoric extractant, which may in turn for example be Di(2-ethylhexyl)phosphoric acid (DEPHA), in an aliphatic diluent. Aqueous ammonia 68, for example at about 200 g/L, is used for neutralising stripped organic, dilute sulphuric acid 70 is used to scrub feed liquor at about 35 g/L and strip feed liquor at about 18 g/L.

The solvent extraction impurity removal step 16 is operated to provide a raffinate 72 that contains a minimal level of manganese, for example less than about 10 mg/L Mn. Near complete co-extraction of zinc, calcium and copper are also achieved. Gypsum 74 may be precipitated from stripping and passed to tails 76 with the manganese, zinc, calcium and copper. Impurities are precipitated from the strip liquor in a precipitation stage 78 to which lime is added for pH modification, and removed in a subsequent filtration step 80.

The raffinate 72, rich in nickel and cobalt, is passed to the nickel and cobalt recovery step 18. The nickel and cobalt recovery step 18 comprises a solvent extraction process 84 in which a nickel and cobalt sulphate product 86 is directly crystallised and an ammonium sulphate containing raffinate 88 directed to a plant (not shown) by which an ammonium sulphate product (not shown) may be realised. The solvent extraction process 84 is operated in a counter-current array of mixer-settlers comprising, for example, 4 extracting, 3 scrubbing and 2 stripping stages, without inter-stage pH control. The organic phase is a carboxylic acid extractant, for example 40% Versatic 10™ in Vivasol™ diluent.

Aqueous ammonia 90, for example at about 200 g/L, is used for neutralising stripped organic, dilute sulphuric acid 92 is used to scrub feed liquor at about 35 g/L and strip feed liquor at about 18 g/L.

The nickel sulphate product amongst the nickel and cobalt sulphate product 86 is recovered as nickel sulphate hexahydrate, whereas the cobalt sulphate is recovered as cobalt sulphate heptahydrate. Crystallisation of both the nickel sulphate hexahydrate and cobalt sulphate heptahydrate is achieved by stripping the loaded organic phase with a sulphuric acid strip solution. The concentration of the sulphuric acid used to strip the nickel and cobalt from the loaded organic phase is not particularly important but is relative to the nickel and cobalt concentrations. The concentration of sulphuric acid used should be high enough to drive the stripping reaction to the right (e.g. the formation of NiSO₄·6H₂O and CoSO₄·7H₂O in the present case) and to ensure that the solubility product value of the nickel sulphate hexahydrate and cobalt sulphate heptahydrate 86 at the process conditions (for example, at the operating temperature) is exceeded and maintained during the stripping step. Typically, the sulphuric acid strip solution will contain concentrated (ie. 98%) H₂SO₄. But in an alternative embodiment, the sulphuric acid strip solution will contain 10-450 g/L H₂SO₄. In preferred forms, the process includes recirculating the strip solution (which is depleted in sulfuric acid) but includes high Ni²⁺ and Co²⁺ concentrations, typically of 80-100 g/L of Ni²⁺ and 8-13 g/L of Co²⁺, present to ensure the solution saturation levels of the nickel sulphate hexahydrate and cobalt sulphate heptahydrate is exceeded with the addition of the fresh nickel and cobalt loaded organic phase from the extraction process. The nickel and cobalt content is stripped as a more dense solid phase in the bottom of the solvent extraction mixer unit by addition of the sulphuric acid, from where it can be recovered by gravity/centrifuge and washing techniques as appropriate. Once the solid nickel sulphate hexahydrate and cobalt sulphate heptahydrate product is removed the essentially nickel and cobalt-free aqueous and organic phases are separated by conventional means, where the organic phase is recycled back to the solvent extraction process 18 with the aqueous stream being returned to upstream processes as part of the overall process water balance. The amount of sulfuric acid in the strip solution is dependent on the nickel and cobalt concentration of nickel and cobalt in the organic extractant phase. The nickel sulphate and cobalt sulphate crystals 86 produced in the solvent extraction step 18 are passed to a dissolution/repulping step 94 in high purity water, after which they are passed to a polishing step 96. The polishing step 96 comprises one or more ion exchange (IX) steps that may, in one example, utilise a resin such as Lewatit® VP OC 1026 that is known to have high selectivity for iron and zinc over nickel and cobalt. Lewatit® TP 207 is another option known to the Applicants, with particular application in removal of trace copper. Alternatively, a solvent extraction step using D2EHPA, which contains the same active extractant reagent as the Lewatit® VP OC 1026 resin could be used. The polishing step 96 further comprises a polishing filter to substantially remove any entrained organic carbon.

The polishing step 96 provides a mixed nickel sulphate and cobalt sulphate solution 98 that may be utilised, in one application, as feed for the production of PCAM. The Applicants have envisaged that in one form of the invention manganese sulphate may also intentionally be present in the solution 98 as feed for the production of PCAM.

The target purity of the solution 98 is about 120 g/L nickel. Trace elements other than cobalt and manganese are intended to be controlled to levels at which the nickel to trace element ratio is >20,000 times.

The loading and stripping of the nickel and cobalt in the solvent extraction process 18 and crystallisation process can be carried out at or slightly above ambient temperature. By way of example, the temperature may be from ambient up to 50° C. However, no thermal energy input is generally required.

It is believed that this combined nickel and cobalt solvent extraction and crystallisation method of the present invention is the first development and implementation of such technology for making an ultra-pure (specialty chemical) nickel and cobalt containing product. The development of a purification and crystallisation (metal recovery) step into a single operation has, to the best of the knowledge of the or each inventor, not been achieved in the metal industry, let alone the nickel industry.

The inventors have also developed a method that allows high purity nickel sulphate and cobalt sulphate crystals to be prepared in an integrated method that seeks to generate a low cost and high purity nickel sulphate and cobalt sulphate product, and seeks to overcome one or more shortfalls of existing methods. Importantly, the methods of the invention differ significantly from Pressure Acid Leach (PAL) and High Pressure Acid Leach (HPAL) “whole of ore” prior art methods, which are both designed to treat nickel-cobalt rich lateritic ore.

In accordance with the second embodiment of the present invention, the present invention further provides a method for the optimisation of feed for downstream processing, wherein the method comprising the following method steps:
(i) Leaching an ore or concentrate at a first site to produce a pregnant leach solution containing one or more target metals;
(ii) Passing the pregnant leach solution to one or more impurity removal steps to produce an at least partially purified product;
(iii) Producing an intermediate product from the at least partially purified product from step (ii);
(iv) Transporting the intermediate product from step (iii) to a second site located remotely from the first site; and
(v) Conducting downstream processing of the intermediate product from step (iii) at the second site.

The first site is, in a preferred form of the present invention, at or very near the mine site from which an ore containing one or more target metals is produced. The one or more target metals of step (i) include nickel. In this form of the invention the ore or concentrate leached in step (i) is a nickel containing ore or concentrate.

The one or more impurity removal steps of step (ii) comprise the precipitation of iron and aluminium. The one or more impurity removal steps of step (ii) further comprises an upgrade step. The upgrade step is, in one form, provided as a solvent extraction step, utilising a carboxylic acid extractant, for example Versatic 10™.

Step (iii) comprises the crystallisation of the intermediate product. In one form of the present invention, step (iii) comprises the direct crystallisation of the intermediate product. This direct crystallisation provides an intermediate metal sulphate, for example a nickel sulphate, and is carried out in accordance with the process described in International Patent Application PCT/AU2019/051044 (WO 2020/061639), the entire content of which is explicitly incorporated herein by reference.

The intermediate product is produced in a manner that minimises the moisture content, so as to avoid the transport of that moisture in step (iv).

The intermediate product of step (iii) is provided, for example, in the form of an intermediate nickel and cobalt sulphate. The downstream processing of the intermediate product at the second site comprises one or more further impurity removal steps, for example comprising one or more ion exchange steps, or alternatively solvent extraction steps. The downstream processing may further comprise an initial dissolution/repulping of sulphate crystals prior to passing to the one or more ion exchange steps. The downstream processing may still further comprise a polishing step whereby entrained organic carbon is removed.

In one form of the present invention the downstream processing of the intermediate product at the second site provides one or more precursor cathode active materials (PCAM). The PCAM may be transferred to a PCAM refinery for further processing.

The method of the present invention, in accordance specifically with the first described embodiment thereof, may be further understood with reference to the following non-limiting example(s).

### EXAMPLES

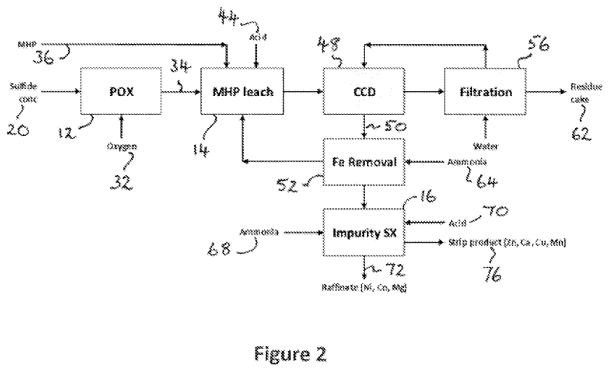

A two-week continuous pilot plant campaign was operated using a plant that comprised the following integrated unit operations, as shown in FIG. 2, being substantially similar to those of the method 10 of the first embodiment of the present invention, such that like numerals denote like parts:
1. Total high temperature pressure oxidation 12 (POX, 210° C.) of a nickel sulphide flotation concentrate 20;
2. Leaching 14 of an MHP 36 in POX discharge slurry 34;
3. Solid-liquid separation and washing, comprising counter-current thickening 48 and filtration 56;
4. Residual iron/aluminium precipitation 52 using ammonia 64, providing a resultant pregnant leach solution (PLS).

The product liquor or pregnant leach solution was stored for subsequent treatment through solvent extraction (SX).

In addition, PLS produced in a separate campaign was processed through Impurity SX (ISX) 16 where an organic containing DEHPA was used to extract Zn, Ca, Cu and Mn away from the contained Ni, Co and Mg. ISX raffinate was stored for recovery of contained Ni—Co in future campaigns.

### Nickel-Cobalt Deportment

A summary of the significant nickel and cobalt inputs/outputs for the campaign are set out below in Table 1.

Recovery of nickel from solid feeds to PLS was in excess of 98%. POX leach extractions were typically 97%, whilst that from MHP was approximately 100%. Soluble loss was <0.2% with scope for further reduction. As expected, cobalt recovery lagged nickel to some extent primarily due to lower POX extractions (94%) likely as a result of the lower cobalt head grade and closer association with iron (which is largely precipitated during POX).

TABLE 1
Nickel and Cobalt Deportment

| | | Solids | | | Liquor | | | Total | | Deportment | |
|---|---|---|---|---|---|---|---|---|---|---|---|
| | | Mass | Ni | Co | Volume | Ni | Co | Ni | Co | Ni | Co |
| | | kg | % w/w | % w/w | L | g/L | g/L | kg | kg | % | % |
| POX/MHP | Inputs | | | | | | | | | | |
| to PLS | Sulfide conc | 739 | 14.3 | 0.2 | | | | 105.9 | 1.8 | | |
| | MHP | 207 | 45.2 | 1.8 | | | | 93.7 | 3.8 | | |
| | Outputs | | | | | | | | | | |
| | Residue cake | 332 | 0.8 | 0.04 | 168 | 2.2 | 0.09 | 3.1 | 0.2 | 1.6% | 2.7% |
| | PLS | | | | 6252 | 31.4 | 0.87 | 196.5 | 5.4 | 98.4% | 97.3% |
| Impurity | Inputs | | | | | | | | | | |
| SX | PLS | | | | 3422 | 26.8 | 0.65 | 91.7 | 2.2 | | |
| | Outputs | | | | | | | | | | |
| | ISX Raffinate | | | | 3733 | 24.6 | 0.57 | 91.7 | 2.1 | 100% | 96.5% |
| | Strip product liquor | | | | 2836 | 0.010 | 0.028 | 0.0 | 0.1 | 0.03% | 3.5% |

For Impurity SX, nickel losses to the impurity strip product stream were negligible at 0.03%. Cobalt losses were higher and are governed by the Co—Mn selectivity of the DEHPA extractant. Cobalt losses have been reduced in subsequent testing with relaxation of manganese target levels with a view to making manganese available in the product as feed for PCAM production.

### POX to PLS Summary

A total of 739 kg of sulphide concentrate was processed during a continuous pilot plant campaign at an average rate of 2.3 kg/h. MHP addition to the POX residue was progressively increased across the campaign to elucidate both the chemistry impacts as well as the process economics. MHP input rate commenced at 0.20 t MHP solids per t sulphide concentrate solids (t/t) and were increased ultimately to 0.35 t/t.

POX treatment of the sulphide concentrate generated a discharge liquor containing 24 g/L H₂SO₄. This acid is able to be fully utilised to leach MHP at a rate of 0.22 t/t, representing an additional 70% nickel input over and above that contained in the sulphide concentrate solids. This input has several consequential economic benefits compared to stand-alone refining of either sulphide concentrate or MHP, as described below.

For stand-alone sulphide POX:
1. Elimination of the need for an alkali to neutralise POX discharge acid (typically limestone or ammonia);
2. Elimination of the reaction products associated with neutralisation (typically gypsum or ammonium sulphate) with consequent disposal costs and associated nickel losses;
3. Elimination of oxidant necessary to oxidise residual Fe(II) in POX discharge liquor (typically ~1 g/L).

For stand-alone MHP refining:
1. Elimination of acid requirement for initial MHP input (up to 0.22 t/t);
2. Elimination of reductant necessary to achieve high Co (and Mn) leach extent.

This elegant synergy permits essentially complete dissolution of MHP in POX discharge slurry, whilst generating a liquor at pH 3.5 containing ~50 g/L Ni, ~20 mg/L Fe(t) and ~20 mg/L Al. Low soluble iron levels significantly simplify downstream treatment.

It has been demonstrated that additional MHP input (up to 0.35 t/t) can be accommodated by way of input of fresh sulfuric acid to maintain slurry pH at <3.5. Acid consumption was as expected based on MHP composition, equating to ~750 kg H₂SO₄ per t MHP solids.

Separation and washing of the solids leached residue was achieved in a four stage counter-current decantation circuit (CCD).

The solid and liquid phases in the neutralised leached slurry were separated using a counter-current array of thickeners (four stages) followed by filtration (three stage displacement wash). A wash ratio of ~1.4 v/v was used across the filters equating to 1.1 v/v across the CCD's. Thickening performance was adequate achieving underflow solids content of 35-45% w/w with stage floc consumption of ~50 g/t solids. Pressure filtration achieved filter cake solids content of 65-70% w/w. Overall nickel soluble loss was <0.2% with scope for further reduction.

CCD1 overflow liquor was treated with ammonia to precipitate remaining Fe and Al and generate PLS suitable for solvent extraction feed. Given the low level of Fe and Al present in this feed liquor, the duty on this circuit was extremely low. Fe and Al were consistently removed to <1 mg/L each with PLS neutralised to pH 4.5-5.0. Precipitated solids (21% Fe, 11% Ni, 0.1% Co) were removed in a thickener and recycled upstream to MHP leach for recovery of contained Ni and Co. Given the low mass flow of these solids the nickel recycle attributable to this stream is <0.5% (relative to total nickel in feed).

The average PLS grade across the campaign was 31 g/L Ni. However, for the last five days of pilot plant operation, as a result of both higher MHP input (0.35 t/t) and several water balance improvements, the average PLS grade was 36 g/L Ni. For this optimised period the full PLS composition is given in Table 2 below.

TABLE 2
Optimised PLS composition, Campaign 3A

| | PLS |
|---|---|
| | mg/L |
| Ni | 36252 |
| Co | 1015 |
| Cu | 443 |
| Zn | 165 |
| Fe | <1 |
| Al | <1 |
| Mn | 1375 |
| Mg | 7442 |
| Ca | 296 |

### Impurity SX Summary

A total of 3422 L of PLS was processed over this pilot plant campaign at an average rate of 10.4 L/h. Overall uptime for SX was 98% with operational performance generally stable as a result.

Impurity SX used an organic phase containing 20% v/v DEHPA in an aliphatic diluent. Mixer-settlers were used for all contacting duties arranged in a counter-current array comprising 4 extract, 3 scrub and 2 strip stages. Aqueous ammonia (200 g/L NH₃) was used for neutralisation of the stripped organic; dilute sulfuric acid was used for scrub feed liquor (35 g/L) and strip feed liquor (18 g/L). No inter-stage pH control was used.

The circuit was operated to achieve a raffinate of <10 mg/L Mn, with near complete co-extraction of Zn, Ca and Cu achieved. Co loss to strip was mitigated via scrubbing of the loaded organic, with scrub raffinate returned to extraction. Partial extraction of magnesium (~10%) was consequential and can be reduced, if desired, through the use of additional extraction stages.

The strip circuit was operated to generate a strip product liquor at ~400 mg/L Ca to prevent gypsum precipitation. Whilst technically successful, this results in the generation of a large volume of dilute product liquor, which is far from ideal for an integrated refinery. It is intended to test lower aqueous strip feed rates in subsequent campaigns in order to intentionally precipitate and separate a gypsum slurry within the strip circuit, as practiced commercially elsewhere. This will permit a ~90% reduction in strip product liquor volume.

The average composition of the Impurity SX feed and product liquors (PLS, raffinate, strip product) for the campaign are set out in Table 3 below.

TABLE 3
Impurity SX feed/product stream composition, Campaign 3A

| | PLS | Raff | Strip Pr |
|---|---|---|---|
| | mg/L | mg/L | mg/L |
| Ni | 26802 | 24566 | 10 |
| Co | 649 | 574 | 28 |
| Cu | 448 | 11 | 526 |
| Zn | 98 | 0 | 118 |
| Mn | 775 | 3 | 932 |
| Ca | 305 | 7 | 359 |
| Mg | 7675 | 6397 | 842 |

Unlike the conventional leaching philosophy for leaching of sulphides (or nickel sulphide concentrates), with regard to the first embodiment of the present invention the Applicants have recognised the value of the whole feed concentrate and consider sulphide sulphur as an additional resource to be leached in addition to the nickel and cobalt values. Conventional thinking has always only looked to oxidise the sulphides that were associated with the pay or valuable metals, and have tried to minimise the leaching/conversion of any additional sulphides (non-base metal sulphide minerals) to sulphate ions. By rethinking the conventional theories and considering the other sulphides present as potential sulphuric acid sources the inventors have chosen to use the HTPOX technology to generate sulphuric acid that is used to leach an MHP and thereby increase the nickel and cobalt PLS tenors, to lower overall waste volumes such as the elemental sulphur volumes generated during LTPOX, and also lower the nickel and cobalt CAPEX intensity of the leaching operation.

It is envisaged that a high proportion, for example greater than 98%, of all waste and effluent streams and products from the processing method of the second embodiment of the present invention will be produced and handled at the first site. This is expected to reduce cost and may avoid stricter regulation in place at the second site.

It is further envisaged that processing of crystals, as proposed in step (v) of the second embodiment of the present invention, would be a cleaner operation than the processing of a fine precipitate (MHP) and won't suffer from impurities in entrained mother liquor and extra water washing. This should make this portion of the process of the second embodiment of the present invention more suitable for location in an urban or metropolitan industrial or light industrial setting.

The method of the present invention allows a high nickel tenor (~100 g/L) solution to be fed forward to PCAM production, and there is expected to be no need to separate any cobalt present from nickel prior to finishing the contained metal as high quality PCAM products.

The method of the present invention, separating geographically steps (i) to (iii) from step (v) as it does, is envisaged to reduce capital expenditure (CAPEX) when compared with a process of the prior art that is typically located at a single site. This is considered to particularly be the case if that single site is located in an urban or even industrial setting. For example, an integrated facility located in a city location would, in many jurisdictions, be required to be fully enclosed, which adds additional CAPEX. The provision of steps (i) to (iii) at the first site, for example at a mine site, is expected to allow less CAPEX.

It is understood that an intermediate mixed nickel and cobalt sulphate produced in accordance with the present invention will have significantly lower levels of magnesium, chlorine, copper, zinc, manganese, calcium, and silicon impurities when compared with currently traded intermediate products, for example mixed hydroxide product (MHP) and mixed sulphate product. These impurities and hydroxides consume acid when further processed so require elimination. They add both CAPEX and OPEX wherever they are dealt with, with this being magnified if this is required to occur in an urban or metropolitan industrial or light industrial setting.

As can be seen with reference to the above description, the method of the second embodiment of the present invention avoids the transportation of ores or concentrates to coastal and/or urban or metropolitan industrial areas. This method incorporates the transport of an intermediate product, which can be solubilised to provide a much higher nickel tenor relative to that possible in prior art extraction processes.

It is further envisaged by the Applicants that the first and second embodiments of the above invention can be combined and advantages realised from that combined method. For example, it is to be understood that the method of the second embodiment of the present invention can be applied directed to the method of the first embodiment, such that the intermediate product of step (iii) of the method of the second embodiment may comprise the mixed nickel sulphate and cobalt sulphate solution of the first embodiment.

The forgoing description is to be considered non-limiting. Modifications and variations such as would be apparent to the skilled addressee are considered to fall within the scope of the present invention.

1.-38. (canceled)

39. A method for the optimisation of feed for downstream processing, the method comprising the method steps of:
(a) passing a sulphide ore concentrate containing nickel and cobalt to a first leach step comprising a high temperature pressure oxidative leach, in which is produced a leach discharge slurry and a residual acid;
(b) passing an intermediate product comprising nickel and cobalt to a second leach step, in which is produced a pregnant leach solution; and
(c) combining the leach discharge slurry of step (i) with the mixed hydroxide precipitate of step (ii) in the second leach step,
wherein the residual acid generated in the first leach step is used to leach the intermediate product in the second leach step and provides a pregnant leach solution containing one or more of nickel and cobalt.

40. The method of claim 39, wherein the intermediate product is a mixed hydroxide precipitate.

41. The method of claim 39, wherein the high temperature pressure oxidative leach operates with one or more of the following conditions:
(a) a pressure of between about 2500 to 3000 kPa;
(b) an oxygen overpressure of between about 400-700 kPa, for example about 700 kPa;
(c) a temperature of between about 200-220° C., for example about 210° C.;
(d) a retention time of between 40 to 70 minutes, for example about 50 minutes; and/or
(e) between about 15 to 30 g/L sulfuric acid, for example about 24 g/L sulfuric acid.

42. The method of claim 39 wherein the second leach step is operated with one or more of the following conditions:
(a) atmospheric pressure;
(b) a temperature of about 80° C.;
(c) a retention time of between about 70-100 minutes, for example between about 78-97 minutes; and/or
(d) a pH of between 2.8-3.

43. The method of claim 39, wherein the pregnant leach solution from the second leach step is passed to an iron removal step to substantially remove iron therefrom whilst retaining nickel and cobalt in solution.

44. The method of claim 43, wherein aluminium is also removed in the iron removal step.

45. The method of claim 43, wherein the iron removal step comprises the modification of the pH of the pregnant leach solution so as to precipitate the iron and optionally aluminium.

46. The method of claim 39, wherein the method of the present invention further comprises an impurity removal step, in which a number of impurity elements are removed from the pregnant leach solution.

47. The method of claim 46, wherein the impurity elements include one or more of zinc, calcium, copper and manganese.

48. The method of claim 46, wherein the impurity removal step is provided in the form of a solvent extraction step.

49. The method of claim 48, wherein the solvent extraction step utilises:
(a) an organophosphoric extractant; or
(b) di(2-ethylhexyl)phosphoric acid (DEPHA) in an aliphatic diluent.

50. The method of claim 39, wherein the method further comprises a nickel and cobalt recovery step, in which nickel and cobalt are recovered from the pregnant leach solution.

51. The method of claim 50, wherein the nickel and cobalt recovery step is provided in the form of a solvent extraction step.

52. The method of claim 50, wherein the nickel and cobalt recovery step provides the direct crystallisation of nickel and cobalt.

53. The method of claim 51, wherein an ammonium sulphate containing raffinate is produced in the solvent extraction step.

54. The method of claim 39, wherein nickel is recovered in the form of nickel sulphate hexahydrate crystals.

55. The method of claim 39, wherein cobalt is recovered in the form of cobalt sulphate heptahydrate crystals.

56. The method of claim 50, wherein the method further comprises a repulping step in which the recovered nickel and cobalt is repulped and a mixed nickel sulphate and cobalt sulphate solution produced.

57. The method of claim 56, wherein the mixed nickel sulphate and cobalt sulphate solution contains about 120 g/L nickel.

58. The method of claim 56, wherein trace elements other than cobalt and manganese are present in the mixed nickel sulphate and cobalt sulphate solution at levels at which the nickel to trace element ratio is >20,000 times.

59. A method for the optimisation of feed for downstream processing, the method comprising the following method steps:
(a) leaching an ore or concentrate containing nickel and cobalt at a first site to produce a pregnant leach solution containing one or more target metals of nickel and/or cobalt;
(b) passing the pregnant leach solution to one or more impurity removal steps to precipitate iron and aluminium and thereby produce an at least partially purified product;
(c) crystallising an intermediate product from the at least partially purified product from step (ii), wherein the intermediate product comprises an intermediate metal sulphate, an intermediate nickel sulphate and/or an intermediate cobalt sulphate;
(d) transporting the intermediate product from step (iii) to a second site located remotely from the first site; and
(e) conducting downstream processing of the intermediate product from step (iii) at the second site comprising one or more further impurity removal steps.

60. The method of claim 59, wherein the one or more impurity removal steps of step (ii) further comprises an upgrade step.

61. The method of claim 60, wherein the upgrade step is provided in the form of a solvent extraction step.

62. The method of claim 60, wherein the upgrade step utilises:
(a) a carboxylic acid extractant; or
(b) Versatic 10™.

63. The method of claim 59, wherein step (iii) comprises the direct crystallisation of the intermediate product.

64. The method of claim 63, wherein the intermediate product of step (iii) further contains manganese sulphate.

65. The method of claim 59, wherein the intermediate product is produced in a manner that minimises its moisture content.

66. The method of claim 59, wherein the further impurity removal steps comprise one or more ion exchange or solvent extraction steps.

67. The method of claim 59, wherein the downstream processing of the intermediate product at the second site provides one or more precursor cathode active materials (PCAM).

68. The method of claim 59, wherein step i) comprises:
(a) passing a sulphide ore concentrate containing nickel and cobalt to a first leach step comprising a high temperature pressure oxidative leach, in which is produced a leach discharge slurry and a residual acid;
(b) passing an intermediate product comprising nickel and cobalt to a second leach step, in which is produced a pregnant leach solution; and
(c) combining the leach discharge slurry of step (i) with the mixed hydroxide precipitate of step (ii) in the second leach step,
wherein the residual acid generated in the first leach step is used to leach the intermediate product in the second leach step and provides a pregnant leach solution containing one or more of nickel and cobalt.
